(19) United States
(12) Patent Application Publication
(10) Pub. No.: US 2008/0050697 A1
(43) Pub. Date: Feb. 28, 2008

(54) Endodontic Instruments

(75) Inventors: Nancy N. Quan, North Hills, CA (US); Ben Wu, San Antonio, CA (US)

Correspondence Address: DISCUS DENTAL IMPRESSIONS, INC., 8550 HIGUERA STREET, CULVER CITY, CA, 90232, US

(73) Assignee: DISCUS DENTAL, LLC, Culver City, CA (US)

(21) Appl. No.: 11/930,038

(22) Filed: Oct. 30, 2007

Related U.S. Application Data
(63) Continuation of application No. 11/591,797, filed on Nov. 1, 2006.
(60) Provisional application No. 60/732,367, filed on Nov. 1, 2005.
(60) Provisional application No. 60/732,361, filed on Nov. 1, 2005.
(60) Provisional application No. 60/732,047, filed on Nov. 1, 2005.
(60) Provisional application No. 60/732,039, filed on Nov. 1, 2005.

(51) Int. Cl. A61C 3/00

(52) U.S. Cl. 433/141

(57) ABSTRACT

A method of manufacturing endodontic instruments is disclosed. Each of the instruments includes a substantially non-cutting pilot portion, a relatively short working portion, and a flexible shank portion which is of a substantially smaller average circumferential span than the working portion. The working portion of the instrument has a maximum circumferential span larger than that of the blank from which it is made. The instrument may have a handle at its distal end for manual manipulation, or may be adapted for attachment to a mechanical handpiece. The non-cutting pilot, the short length of the working portion, and the flexibility of the shank combine to allow the instrument to be used in curved root canals without causing undue change in the natural root canal contours.

### CROSS-REFERENCE TO RELATED APPLICATIONS

This application claims the benefit of U.S. Provisional Patent Application 60/732,367 entitled “Endodontic Instrument” filed Nov. 1, 2005; U.S. Provisional Patent No. 60/732,047 entitled “Endodontic Instrument” filed Nov. 1, 2005; U.S. Provisional Patent Application No. 60/732,631 entitled “Endodontic Instrument” filed Nov. 1, 2005; and U.S. Provisional Patent Application No. 60/732,039 entitled “Treated Endodontic Instrument” filed Nov. 1, 2005 the entire contents of which are incorporated by reference.

### FIELD OF THE INVENTION

This invention relates to endodontic instruments and a method for manufacturing endodontic instruments in general. More specifically, this invention relates to endodontic instruments for use in root canal dental procedures.

### BACKGROUND OF THE INVENTION

Both circulatory and neural support for a tooth enters the tooth at the terminus of each root. During a root canal operation, any diseased pulp tissue in the root canal is extracted using endodontic files and reamers that are generally tapered. These instruments generally have working surface or portions along the major portions of the file. Since the root canals are small, curved and calcified, the instruments used have to withstand high torsional stresses during such removal process so as not to complicate the treatment by breaking.

The endodontic files and reamers used to clean out and shape the root canal are rotated and reciprocated in the canal by dentists, either manually or with the aid of dental handpieces onto which the files are mounted. Files of increasingly larger diameters are generally used in sequence in order to achieve the desired cleaning and shaping.

Many endodontic instruments used for this operation have torsional limitations. Some of the improved ones are disclosed in U.S. Pat. Nos. 4,538,989, 5,464,362, 5,527,205, 5,628,674, 5,655,950, 5,762,497, 5,762,541, 5,833,457, 5,941,760, and 6293795, the contents of these are incorporated herein by reference. Some of these patents teach endodontic files made with an alloy of nickel/titanium containing more than 40% titanium.

The files and reamers also have varying designs of cutting edges and some of these designs are disclosed in U.S. Pat. Nos. 4,299,571, 4,332,561, 4,353,698, 4,457,710, 4,661,061, 4,850,867, 4,904,185, 5,035,617, 5,067,900, 5,083,923, 5,104,316, 5,275,562, 5,735,689, 5,902,106, 5,938,440, 5,980,250, 6,293,794, and 6,419,488, 6,428,317, and Patent Application Publication Nos. US2002/0137008 A1, and US2004/0023186 A1, incorporated herein by reference. These files have working portions spanning the lengths of the shanks and include helical cutting surfaces.

### SUMMARY OF THE INVENTION

The present invention relates to a method of manufacturing an endodontic instrument or a set of endodontic instruments, the instrument including a pilot portion at its proximal end, a relatively short working portion, and a flexible non-working shank portion towards its distal end that is of a substantially smaller average circumferential span than the working portion. The working portion may be towards the proximal end or towards the mid-portion of the instrument.

According to one embodiment of the invention, a method for manufacturing an endodontic instrument includes:

providing a blank having a longitudinal axis and a circumferential span that is the same as that of a non-working shank of the instrument;

positioning at least a portion of each of said blank away from the non-working shank adjacent a die having walls defining at least partially the shape and circumferential span of a working portion of the instrument;

compressing said blank against said walls of said die with a force sufficient to deform said blank into a shape reflecting said walls of said die to form a working portion;

forming a pilot portion near the end of the instrument adjacent the working portion; and

treating at least a portion of the instrument including at least a portion of the shank, the working portion, the pilot portion or combinations thereof;

wherein said working portion has a circumferential span substantially larger than the circumferential span of the blank.

In one embodiment, at least a portion towards the proximal end of the non-working shank has substantially the same circumferential span as that of the blank. In another embodiment, the entire length of the shank may have a substantially smaller circumferential span than that of the blank. In a further embodiment, the shank may be tapered towards the proximal portion. In yet another embodiment, the shank may have a portion having a reduced circumferential span towards the proximal end to create a weak point.

In one aspect, the treatment includes coating, sandblasting, anodizing, ion implantation, etching, electro-polishing, heat setting, cryogenic treatment, or combinations thereof.

In one embodiment, the treatment may be performed after the instrument has been formed. In another embodiment, the treatment may be performed prior to the compression process. In a further embodiment, the treatment may be performed when the blank is manufactured.

In a further aspect, the instrument or blank may have a coating for improving durability, and/or lubricity and/or improving cutting efficiency and/or strength.

Some treatment methods may also impart a different color to the treated portions. These colored working portions may serve as wear indicators.

According to another embodiment of the invention, the method includes:

providing a set of blanks for making instruments, all the blanks having an identical circumferential span;

positioning at least a portion of each said blank next to a non-working shank portion adjacent a die having walls defining at least partially the shape and circumferential span of a working surface of the instrument;

compressing at least a portion of each of said blank against said walls of said die with a force sufficient to deform said wire into a shape reflecting said walls of said die to form the working portion; and

forming a pilot portion near the end of each of the blank close to the working portion;

wherein the shank portion of each of the instruments in the set is of substantially the same circumferential span as the blank and each working portion has a different circumferential span.

In The present invention further relates to method of manufacturing a set of endodontic instruments including:

providing a set of blanks, each having a distal end and a proximal end, said blanks having varying circumferential spans that are of the same circumferential spans as non-working shank portions of the respective instruments made from them;

positioning at least a portion of each said blank next to the non-working shank portion adjacent a die having walls defining at least partially the shape and circumferential span of a working surface of a dental instrument;

compressing at least a portion of each of said blank against said walls of said die with a force sufficient to deform said wire into a shape reflecting said walls of said die to form a working portion; and

forming a pilot segment near an end of each of the blank close to the working portion;

wherein each blank produces one instrument in the set having a working portion with a predetermined circumferential span that is different from that of the other instruments in the set.

In one aspect, the compression force may be adjusted so that the thicknesses of the working surfaces in the set of instruments are substantially the same, even though the circumferential spans of the working surfaces are different.

According to yet a further embodiment of the invention, a method for manufacturing a set of groups of endodontic instruments includes:

providing a set of groups of blanks, the set and groups each having a finite number of blanks, wherein each blank having a circumferential span, and each group having a different circumferential span from other groups in the set, and one portion of each blank forms the non-working shank of the instrument;

positioning at least a portion of each blank next to the non-working shank adjacent a die having walls defining at least partially the shape and circumferential span of a working portion of the instrument;

compressing said blank against said walls of said die with a force sufficient to deform said blank into a shape reflecting said walls of said die to form a working portion; and

forming a pilot portion near the end of the instrument close to the working portion;

wherein each said working portion has a circumferential span substantially larger than the circumferential span of the blank, and the working portion of one instrument in the group has a different circumferential span and thickness from the others in the same group.

In one the thickness of the working portion of an instrument in one group may be the same as an instrument in another group of the set. In another embodiment, the thickness of the working portion of an instrument in one group may be the same as an instrument in every other group in the set. In a further embodiment, the thickness of the working portion of all instruments in the set may be different.

In one aspect, the number of groups is fewer than number of instruments in the set. In another aspect, the number of groups is one.

According to one embodiment, at least two instruments in the set may be produced from each group of blanks. According to another embodiment, at least three instruments in the set may be produced from each group of blanks. In one aspect, the working surface of each of the other instruments in the set produced from the same group of blanks has a maximum circumferential span and thickness smaller or larger than the circumferential span of the other instruments in the group of the set.

In one aspect, the set of blanks may be provided in a spool. In another respect, the set of blanks may be individual severed pieces.

In one embodiment, at least a portion of each of the instruments in the set including at least a portion of the shank, the working portion, the pilot portion or combinations thereof, may be treated. The treatment may include coating, sandblasting, anodizing, ion implantation, etching, electro-polishing, heat setting, cryogenic treatment, or combinations thereof. In one embodiment, the treatment may be performed after the instrument has been formed. In another embodiment, the treatment may be performed prior to the compression process. In a further embodiment, the treatment may be performed when the blank is manufactured.

In one embodiment, the working portion of any of the embodiments mentioned above may include at least one projecting section, each projecting section extending beyond a radius and defining an apex, and including a leading portion extending forward of the apex and making an angle with the longitudinal axis of the shank of less than about 90° and a trailing edge portion extending rearward of the apex and making an angle of less than about 90° with longitudinal axis of the shank. The apex of the projecting portion defines a point of maximum dimension or circumferential span of the working portion.

In another embodiment, the walls of the die may be configured to produce at least one projecting section, each projection section lies substantially in the plane of the flattened working portion.

In a further embodiment, each projecting section does not twist about the longitudinal axis of the shank portion more than 359 degrees. In yet a further embodiment, the projections do not intersect each other or the longitudinal axis of the working portion.

In one embodiment, a portion of the blank may be positioned adjacent the walls of the die for compression. In another embodiment, the walls of the die may be positioned against the portion of the blank chosen to be compressed.

The present invention also relates to an endodontic instrument including:

a relatively short working portion having a proximal end, a distal end and including at least one projecting section;

a pilot portion adjacent the proximal end of the working portion; and

a flexible shank portion adjacent the distal end of the working portion, a portion of said flexible shank is of a substantially smaller average circumferential span than the working portion;

wherein at least a portion of the shank, the working portion, the pilot portion, or combinations thereof has been treated.

The configuration of the working portion of the instrument may include any of those configurations mentioned above.

The present invention still further relates to set of endodontic instruments, each including an instrument having:

a relatively short working portion having a proximal end, a distal end and including at least one projecting section;

a pilot portion adjacent the proximal end of the working portion; and

a flexible shank portion adjacent the distal end of the working portion and having a longitudinal axis, at least a portion of the shank portion has a substantially smaller average circumferential span than the working portion, and has a different circumferential span from that of any other instrument in the set;

wherein the thickness of each of the working portions in the set of instruments is substantially the same as that of others in the set, and the circumferential span of one working portion is different from that of others in the set.

The present invention yet still further relates to a set of groups of endodontic instruments, each instrument having:

a relatively short working portion;

a pilot portion; and

a flexible shank portion having a longitudinal axis, at least a portion of the shank portion has a substantially smaller average circumferential span than the working portion, and has a different circumferential span from that of instruments in other groups;

wherein the thickness and circumferential span of one of the working portions in the groups are different from those of others in the group.

In one embodiment, the thickness of the working portion of one instrument in one group in the set may be the same as the thickness of another instrument in a different group of the set. In another embodiment, the thickness of the working portion of one instrument from each group in the set is identical. In a further embodiment, the thicknesses of the working portion of all the instruments in the set are different.

In one aspect, at least a portion of each of the instruments including the shank, the working portion, the pilot portion or combinations thereof has been treated, as noted above. The treatment includes coating, sandblasting, anodizing, ion implantation, etching, electro-polishing, heat setting, cryogenic treatment, or combinations thereof.

In one embodiment, the treatment may be performed after the instrument has been formed. In another embodiment, the treatment may be performed prior to the compression process. In a further embodiment, the treatment may be performed when the blank is manufactured.

In one aspect, the working portion may have any of the configurations of any of the above embodiments.

Compression as described above may include coining, stamping, cold pressing, molding or casting. While coining, stamping, cold pressing may be operated at ambient temperature or higher, molding or casting may be performed at elevated temperatures.

In another aspect, any of the above described instruments may have a handle at its distal end for manual manipulation. In another aspect, the instrument may be adapted for attachment to a mechanical handpiece, including a rotary or a vibratory handpiece.

One end of the shank portion adapted for attachment to a handle portion may be treated. The treatment may improve the attachment strength and minimize separation of the shank portion from the handle portion.

The substantially non-cutting pilot, the short length of the cutting segment, and the flexibility of the shaft combine to allow the instrument to be used in curved root canals without causing undue change in the natural root canal contours.

The blank may have a substantially spherical, a substantially rectangular, a substantially triangular, or a substantially elliptical cross-section.

In one embodiment, the pilot portion may be a non-cutting portion. In another embodiment, the pilot portion may include abrasive surfaces. In yet another embodiment, the pilot portion may be a continuous extension of the working portion.

In one embodiment, the pilot portion may be about the same length as the working portion. In another embodiment the pilot portion may be an extension at the end of the working portion.

The present invention together with the above and other advantages may best be understood from the following detailed description of the embodiments of the invention illustrated in the drawings below.

### BRIEF DESCRIPTION OF THE DRAWINGS

FIG. 1 shows a prior art endodontic instrument;

FIGS. 2, 2a, 2b, 2c and 2d each show a top view, and FIG. 2d1 shows a front view of embodiments of an endodontic instrument made with methods according to the present invention;

FIG. 3 shows a perspective view of FIG. 2;

FIGS. 3a and 3b each show a perspective view of an embodiment of an endodontic instrument having a different configuration for the working portion;

FIGS. 3c and 3d each shows an embodiment of an endodontic instrument of the present invention having a predetermined weak point or portion along the shank portion;

FIG. 4 shows a group of a set of instruments of the present invention, each instrument having a different diameter shank portion and a different circumferential span working portion having the same thickness;

FIG. 4a shows a group of a set of instruments of the present invention, each instrument having the same diameter shank portion, a different circumferential span working portion having a different thickness;

FIGS. 5, 5a and 5b show an instrument of the present invention having a handle attached thereto;

FIG. 6 shows a block diagram of an exemplified process useful for the present invention;

FIG. 6a is a side view of the compression process of the present invention as exemplified in FIG. 6;

FIG. 6b shows a top view of the compression process of the present invention as exemplified in FIG. 6;

FIG. 7 shows schematic diagram of a portion of an apparatus useful for practicing the process and making an instrument of the present invention;

FIG. 7a shows a schematic diagram of another portion of an apparatus for making an instrument of the present invention;

FIG. 7b shows the configuration of a die useful for making an instrument of the present invention;

FIGS. 7c and d show the side and top views respectfully of two pairs of molds for compressing the blank.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized.

The description sets forth the features and the processes for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention.

The field of endodontics involves diseases of the tooth pulp, commonly known as a root canal, and typically requires the dentist to remove infected material from within the pulp of the tooth. The root canal itself is the space within the tooth that carries the blood supply into the tooth and contains the pulp, as noted before. Within the root canal the pulp contains the nerve endings, which causes pain to warn when one bites down too hard on a hard object. From time to time, this space (the root canal) becomes infected and requires the dentist to clean (ream) out the root canal space in order to remove the pulp and/or other infected material. The better designed the instrument, the more efficient the cleaning process.

An endodontic instrument 12 in accordance with the present invention may be used in a root canal procedure. Some exemplary configurations may be found in U.S. Pat. No. 4,850,867, and U.S. publication No. 20020182565, U.S. Pat. No. 7,094,055, WO2002/093265, the contents of which are incorporated herein by reference.

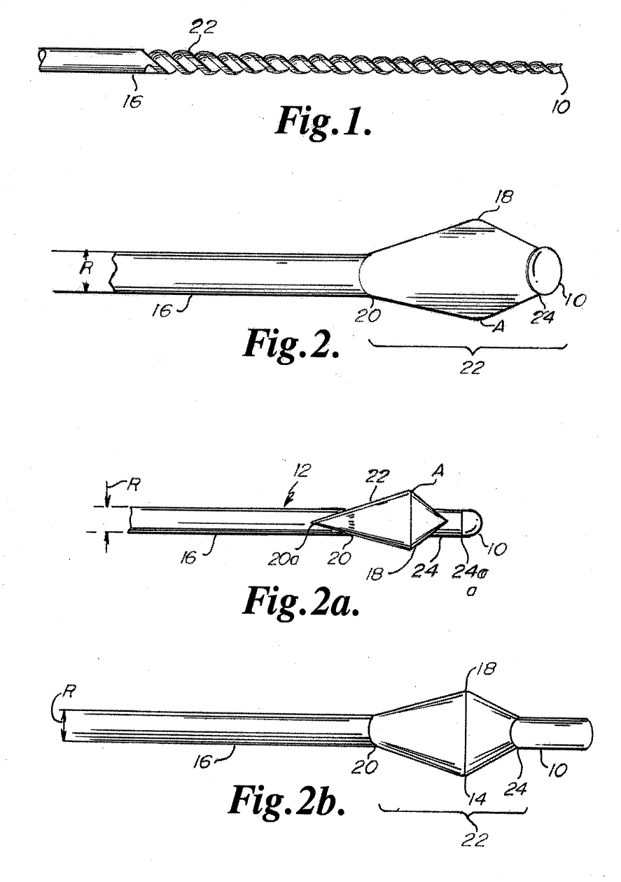

Traditional instruments typically include long, tapered working portions having helical flutes along the entire length of the working portion, such as shown in FIG. 1. These instruments are typically made by grinding a cylindrical wire. Such long working portions also mean more contact area between the root canal and the instrument, thus subjecting the instrument to higher torsional forces during operation.

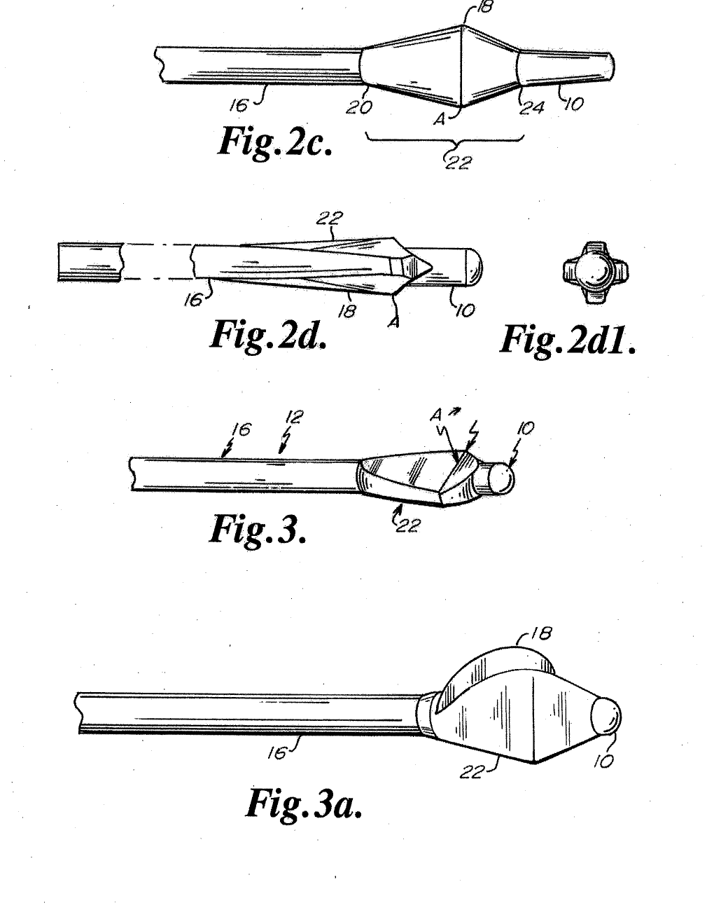

An endodontic instrument of the present invention has a relatively short working portion 22, such as exemplified in FIG. 2, 2a, 2c, 2d, 3, 3a, 3b, 3c, 3d, 4, or 4a. The short working portion 22 may lead to smaller areas of contact with the root canal than traditional instruments. The smaller areas may result in lower torsional forces on the instrument during use. The shorter working portion 22 also may provide the dentist with substantially improved control over where cutting of dentin occurs and therefore causes much less unintended cutting of dentin and change of the natural curvature.

An endodontic instrument 12 of the present invention, such as exemplified in FIG. 2, 2a, 2b, 2c, 2d, 3, 3a, 3b, 3c, 4 or 4a, has a relatively long non-working shank 16, having a proximal end 16a and a distal end 16b. The cross-section of the shank 16 substantially corresponds to that of the blank 30 from which the instrument 12 is made. Substantially no grinding is performed on the shank portion 16 to form the endodontic instrument 12 of the present invention.

The shorter working portion 22 also may provide the dentist with substantially improved control over where cutting of dentin occurs and therefore causes much less unintended cutting of dentin and change of the natural curvature.

The blank 30 may be of a substantially circular, a substantially square, a substantially rectangular, a substantially triangular, or a substantially elliptical cross-section. Hence the shank 16 may have any of these cross-sections.

An instrument 12 of the present invention includes a shank 16 having a small circumferential span or diameter over a major portion of its length, as shown in FIGS. 2, 2a, 2b, 2c, 2d3, 3a, 3b, 3c, 3d, 4 and 4a. The small circumferential span or diameter of the shank 16 of the present invention makes the instrument 12 more flexible. This flexibility allows the instrument 12 to follow the curve of a canal more easily.

The shank portion 16 is also substantially longer than the working portion 22. A traditional instrument, by contrast, has a very short shank portion, if any. The length of the shank portion 16 provides for an instrument 12 that may bend more readily as it encounters any change in direction in the channel of the tooth.

The instrument 12 also has a substantially non-cutting pilot portion 10 towards the proximal end 20 of the working portion 22, as shown in FIG. 2. The substantially non-cutting pilot portion 10, the short length of the working portion 22, in addition to the length and flexibility of the shank 16, all combine to further allow the instrument 12 of the present invention to more easily follow the natural curvature of the entire root canal without causing undue change in the natural root canal contours. It also opens up more choices for materials that may be suitable for constructing the instrument 12, including materials that may not be suitable for traditional instruments, materials that are not traditionally considered as having high degrees of flexibility, or materials having improved strength. Such improvements may be introduced through treatments such as cryogenic treatments, heat setting or combinations thereof.

Such treatments for improved strength, which may introduce a correspondingly undesirable loss in flexibility of the blank sometimes, may still generate blanks that are suitable for the present invention because of the configuration of the instrument 12 of the present invention.

Also, since substantially no grinding is typically performed on the shank portion 16, as mentioned above, no weak points along the shank 16 are introduced by the manufacturing process. This also makes the use of blanks 30 having smaller circumferential spans or diameters possible, and further adds to the flexibility of the instrument 12.

The blank 30 may include a titanium alloy such as nickel-titanium alloy, titanium-nitride alloy, titanium-aluminum-vanadium alloys or similar; stainless steel; silver and silver alloys; aluminum; any amorphous metals; or a similar metal that is amenable to being drawn into a blank of small diameter or circumferential span or a wire-like form. For a titanium alloy, the amount of titanium may be present at, for example, at least about 25% by weight, more for example, may be present at, for example, at least about 50% by weight. The nickel-titanium alloys may also include impurities such as C, O, N, Co, Cr, Zr, Hf, Nb, Pt, Pd, V, Fe or mixtures thereof. Fe may also strengthen and improve ductility of the alloy. These blanks may be made into endodontic instruments 12 having good torsional resistance and good flexibility.

A suitable non-metal may also be used and may include a polymeric alloy such as ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference); any or combinations thereof.

The blank 30 may be present in a continuous spool. When the blank 30 is in a spool, it may undergo a straightening process prior to being cut and/or ground. For a blank of nickel-titanium alloy, the straightening process is not needed as the winding process does not impart a permanent memory to the blank.

In one embodiment, the blank 30 may be cut into the needed dimension prior to feeding the blank 30 through the instrument manufacturing process. In another embodiment, the blank may be fed through the instrument manufacturing process prior to being cut into the required dimension.

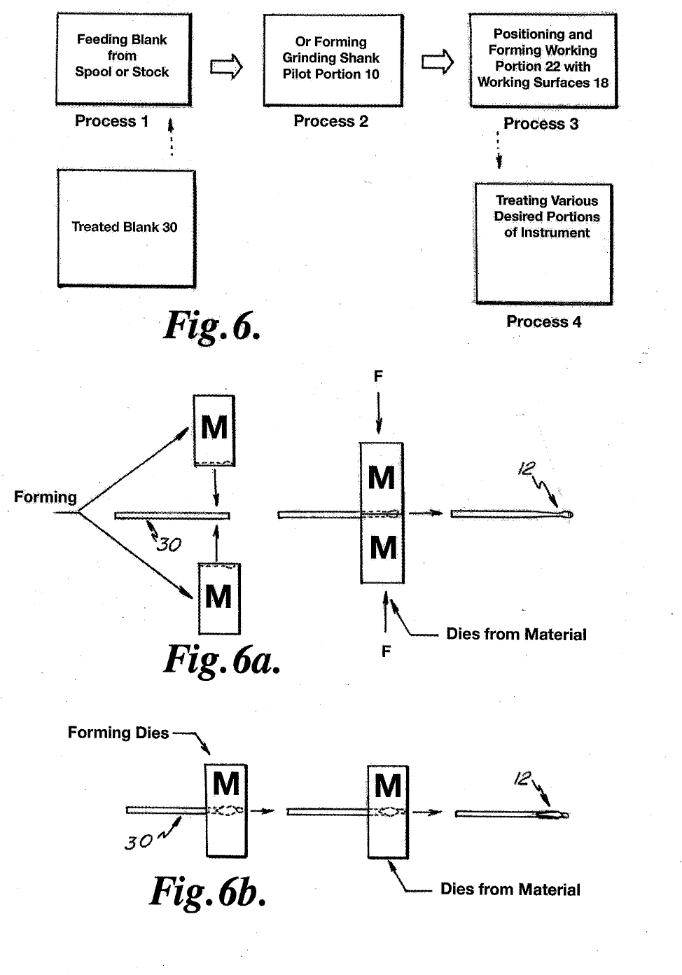

An instrument 12 typically has a length of about 30 mm (1.2 inches), and has a proximal end adapted to be mounted to a conventional handle 25, as shown in FIG. 5, or a rotary handle 25, as shown in FIGS. 5a and 5b. The conventional handle 25 may be adapted for manual cutting of the root canal. The rotary handles 25 may be adapted for mounting to a mechanical handpiece, such as a rotary handpiece or vibratory handpiece.

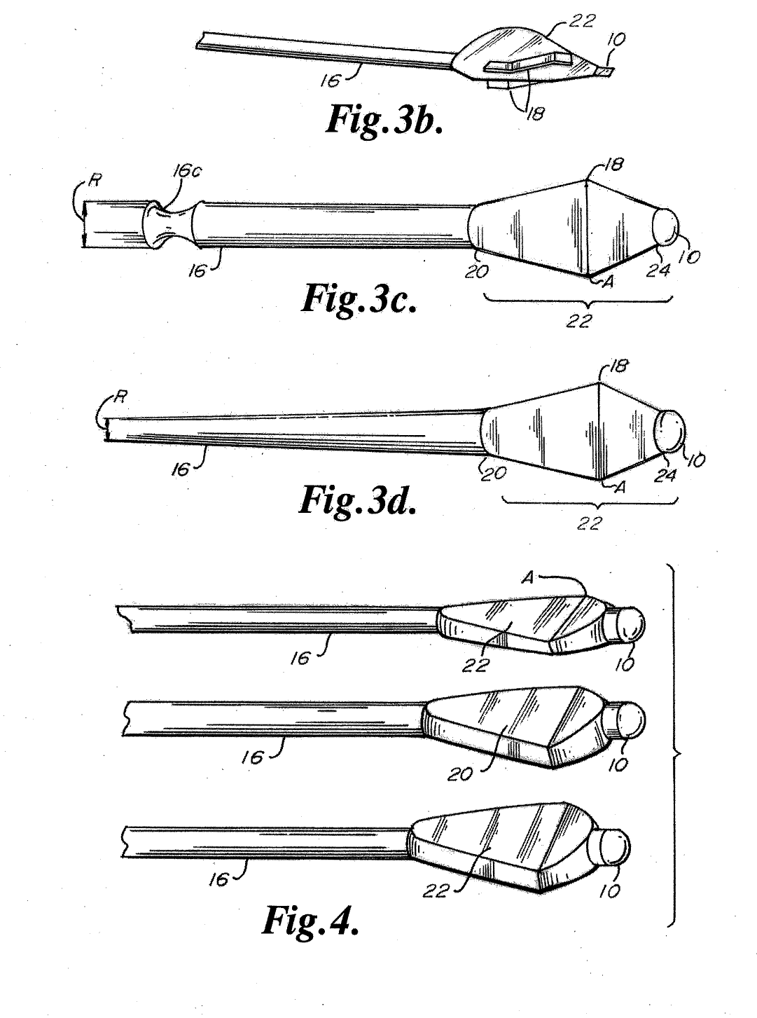

The shank portion 16 may be cylindrical, as shown in FIGS. 2 and 3, or may be of any other cross-section mentioned above, and may have a circumferential span or diameter of between about 0.2 to about 0.8 mm (0.01 and 0.03 inches).

Typical lengths of shank portion 16 ranges from, for example, 1.0 mm to 100 mm, more for example, 10 mm to 50 mm, while the typical working portion 22 ranges from, for example, 0.25 mm to 10 mm, more for example, 1.5 mm to 3.0 mm, even more for example, up to about 14 mm (0.5 inches).

In one embodiment, the working portion 22 may be substantially in one plane. In another embodiment, the working portion 22 may have projections that are out of plane.

In one embodiment, the working portion 22 may be made to be slightly tapered towards the pilot portion 10. In a further embodiment, the working portion 22 may be slightly tapered towards the shank portion 16. In another embodiment, the working portion 22 may be slightly tapered towards both the pilot end 10 and the shank portion 16, as shown, for example, in FIGS. 2, 2a, 2b, 2c, 2d, 3, 3a, 3b, 3c, 3d, 4, and 4a. Any or all of these illustrates embodiments of an endodontic instrument 12 which may be fabricated in accordance with the present invention.

The working portion 22 of the instrument 12 may be flat, or substantially in one plane, and having a thickness, as shown in FIGS. 3, 3a, 4 and 5. In one embodiment, the flattened working portion 22 may vary in thickness, from a thinner edge to a thicker central portion. In another embodiment, the thickness of the working portion 22 may be substantially uniform.

In another embodiment, the working portion 22 may have projections that are out of plane or may be of a wedge-like sections or projections 18 that are not helically wound with respect to the longitudinal axis of the shank 16, as exemplified in FIGS. 2a, 2d, 3, 3a, and 4. The projecting section 18 extends beyond radius R of the shank 16 as measured perpendicular to the longitudinal axis. One or more of these projections 18 may be straight, radiating outward about the working portion 22 in one plane, as shown in FIG. 2a.

In FIG. 2a, there is a pair of oppositely located projecting sections 18. In other embodiments, more than one pair of projecting sections 18, each extending beyond the radius of the shank 16 may be possible, as shown in FIG. 2d.

In one embodiment, as shown in FIG. 2a, at least one of these wedge-like projections 18 may have a radius R and an apex A and includes a leading portion 24a extending forward of the apex A and making an angle with the longitudinal axis of less than about 90°, and a trailing edge portion 20a extending rearward of the apex and making an angle of less than about 90° with the longitudinal axis. In one aspect, the wedge-like projections 18 including the forward and trailing portions 20a and 24a that are typically at an oblique angle to the longitudinal axis.

In another embodiment, each projecting section 18 may not be straight, but may twist about the longitudinal axis of the shank portion 16 not more than 359 degrees, as shown in FIG. 3a.

In yet another embodiment, the projections 18 may be straight or twisted, and do not intersect each other, such as a spade type drill, having a working portion 22 with a plurality of flutes or wedge shaped portions 18 extending beyond the diameter of the shank 16, one of which is in 3b.

In one embodiment, the working portion 22 may have a uniform thickness. In another embodiment, the thickness may vary from a thinner edge to a thicker central portion. The thinner outer surface 18 of the working portion 22 may have better cutting efficiency.

Referring to FIGS. 2 and 2a, 2c and 2d, the working portion 22 may have a slight taper present at both ends of the working portion 20 and 24, as shown. The tapering makes the largest circumferential span section not towards either one of the ends 20 and 24, but either about the mid-section of the working portion 22, or off the mid-section of the working portion 22, as shown in FIGS. 2, 2a, 2b, 2c, 2d, 3, 3a, 3b, 3c, 3d, 4 and 4a.

The working portion 22 may also be suitably tapered in three portions. A first transition portion 20 increases in circumferential span from the distal end or portion of the pilot portion 10 until it meets the main body of the working portion 22. The main body portion then decreases in circumferential span towards its distal end or portion 24, but may be at a larger slope of decrease than the slope of increase from its proximal end or portion 20 towards the main body. The main body of the working portion 22 connects at its distal end or portion 24 to the shank portion 16. Other embodiments are possible, including a reverse taper whereby the proximal end or portion diameter of the working portion 22 may be greater than the distal end or portion diameter, or any other combination.

In the embodiments as exemplified in FIGS. 2, 2a, 2b, 2c, 2d, 3, 3a, 3b, 4 and 4a, the non-working shank 16 is of a substantially cylindrical shape and has a proximal end 16a and a distal end 16b. In other embodiments, shanks 16 having other cross-sectional shapes, such as a triangle, a square or a rectangle, may also be contemplated.

The tapered end 24 of the working portion 22 is contiguous with the distal end 16b of the non-working shank 16. The working portion 22 first widens then reaches an apex A, then narrows until it reaches the diameter of the shank 16. The projections or wedges 18 are seen, in FIG. 2d, to first become thinner until they reach a minimum at apex A then thicker until they reach a thickness equal to the diameter of the shank 16.

In one embodiment, the tapered end 24 may be tapered such that at the point of joining with the distal end 16b of the non-working shank 16, there is a matching of diameters. In another embodiment, the distal end 16b is of a slightly larger diameter than the narrow portion of the non-working shank 16 so that there is a smooth transition from the tapered end 24 of the working portion 22 towards the non-working shank 16. In a further embodiment, the proximal end of the non-working shank 16 may have a slightly larger diameter than working portion 22.

FIG. 2d shows a side elevational view of an embodiment of an instrument 12 of the present invention having four fluted or wedge shaped projections 18 radiating outward from the axis of the shank 16. In FIG. 2d, the two pairs of projecting sections 18 form a square-shape form or a parallelogram. The cross-section of one is exemplified in FIG. 2d1.

FIG. 3 is a perspective view of the embodiment of FIG. 2, showing the thickness of the working portion 22. As shown, the thickness of the working portion 22 is substantially uniform. In other embodiment, the thickness may vary throughout the working portion 22, as noted above. The thickness of the working portion 22 may be determined by the circumferential span, or diameter of the blank 30 used, the configuration of the die, and the circumferential span of the resulting working portion 22.

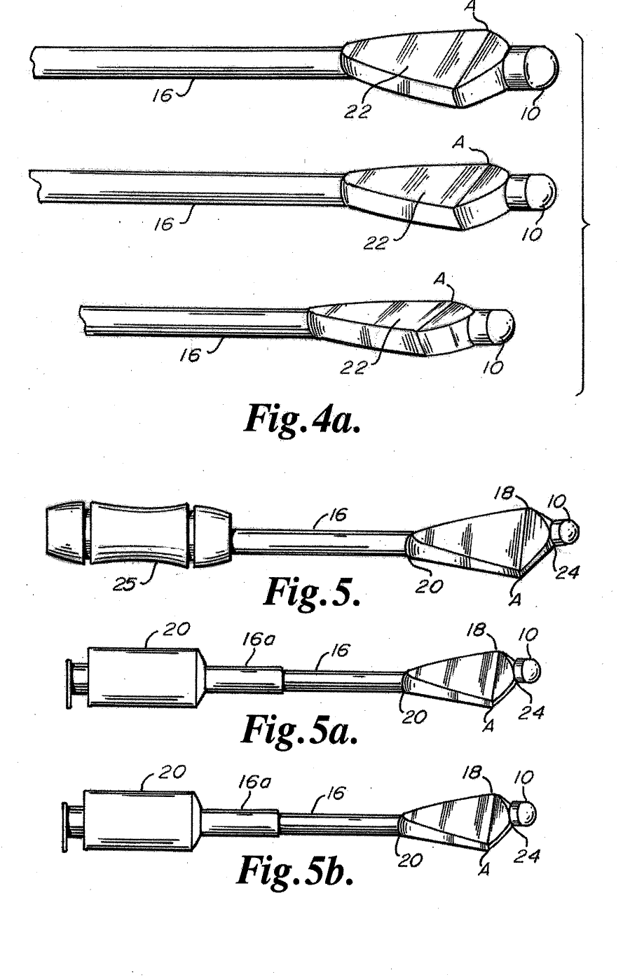

In one embodiment, when using blanks 30 having, for example, the same diameter or circumferential span, to make a series of instruments 12 having different circumferential span working portion 22, the thickness of the working portions 22 varies, such as shown in with a group of set in FIG. 4a. The working portions 22 have substantially uniform thicknesses throughout the structure. In FIG. 4a, the shank portions 16 are of one diameter in the group, while the working portions 22 vary in circumferential spans in the group. As shown, the working portions 22 have different thicknesses. In this embodiment, the need to stock blanks 30 with varying diameters or circumferential spans may be eliminated.

In another embodiment, as exemplified in FIG. 4, a group of a set of instruments 12 of the present invention is made from blanks 30 having different diameters or circumferential spans, resulting in shank portions 16 having different diameters. In this embodiment, the thicknesses of the working portions 22 within a group are the same while the circumferential spans of the working portions 22 within a group vary. In some embodiments, as illustrated in FIG. 4, the thickness of the working portion 22 of a single instrument 12 may be constant. In other embodiments, the configuration of the die may be varied to produce a varied thickness of working portion 22 of a single instrument 12 (not shown). In still other embodiments, the circumferential spans and the thicknesses of the working portions 22 of the group of a set of instruments 12 may vary in a manner similar to that illustrated in FIG. 4a while using blanks 30 of different diameters or circumferential spans.

The thickness of the working portion 22 in a group may be optimized for cutting efficiency, ease of manufacture, or decreased likelihood of fracture during use.

In some embodiments, the length of the working portion 22 may also vary in addition to the circumferential span and configuration. However, in contrast to prior art instruments, the length of the working portion 22 does not exceed the length of the shank portion 16 such that the instrument 12 may preserve its flexibility.

A pilot portion or tip 10 guides the flexible shank 16 within the canal. The pilot portion 10 is substantially non-cutting and may have a diameter small enough to allow an instrument 12 to enter the apical area of the root canal of a human tooth and to act as a guide to follow the canal to the apex. Thus, the purpose of the pilot portion 10 is therefore to guide the instrument 12, and not necessarily to perform any cutting. In one embodiment, the pilot portion 10 may be a non-cutting portion. In some embodiments, the substantially non-cutting portion may include an abrasive surface. The abrasive surface may be imparted through coating, sandblasting, anodizing, ion implantation, etching, electro-polishing or combinations thereof, as further discussed below. In still other embodiments, the pilot portion 10 may have raised edges or other projections on its surface, as long as they do not cause the pilot portion 10 to have a substantial cutting effect.

The length of the pilot portion 10 may also vary, and may be, for example, between about 0.01 and 14 mm long, more for example between about 0.75 and 3 mm.

The pilot portion 10 may be tapered (as shown in FIG. 2c) or nontapered (as shown in FIG. 2b). If tapering is used in the pilot portion 10, it will usually increase in diameter from its proximal end to its distal end is also shown in FIG. 2c.

In FIGS. 2 and 2a, the pilot portion 10 is a short portion extending from the end 20 of the working portion 22. As shown, the pilot portion 10 is a smooth tapered cylinder with a blunt proximal end. In other embodiments, the pilot portion 10 may have rounded (bullet shaped) ends, as exemplified in FIG. 2c.

In FIG. 2 or 2a, the pilot portion 10 is present as a slight extension or a stump at the end 20 of the working portion 22. This may be rounded, and may be generated by grounding or polishing the working end 20.

In FIG. 2b, the pilot portion 10 is almost of the same length as that of the working portion 22. In FIG. 2b, the pilot portion 10 as shown is also a smooth cylinder having a uniform circumferential span, for example, diameter, along its length, except for the end. In other embodiments, the pilot portion 10 may be tapered towards the end, as shown in FIG. 2c. As shown, the end of FIGS. 2b and 2c are not rounded. In other embodiments, the end may also be rounded, such as shown in FIGS. 2 and 2a. In this configuration when the pilot portion 10 is almost as long as the working portion 22, the instrument 12 may be useful a coronal shaper.

In FIGS. 2, 2a, 2b, 2c, 2d, 3, 3a, 3b, 3c, 3d or 4, the cross-section of the leading end of the pilot portion 10a may be of a substantially rectangular shape. In this embodiment, when the instrument 12 encounters a root canal channel that is narrower than the diameter of the shaft used, the nose portion 10a may begin to cut aggressively. With a more rounded nose portion 10a, as illustrated in FIG. 2c, the nose portion 10a has essentially no cutting edge.

Referring again to FIG. 4a, a group of a set of endodontic instruments 12, each made from blanks 30, where each has the same circumferential span or diameter. Each of the instruments 12, as shown in FIG. 4a, has a working portion 22 that is different in circumferential span from another instrument 12 in the group, and the thickness of the projection sections 18 is also substantially different from that of another instrument 12 in the group.

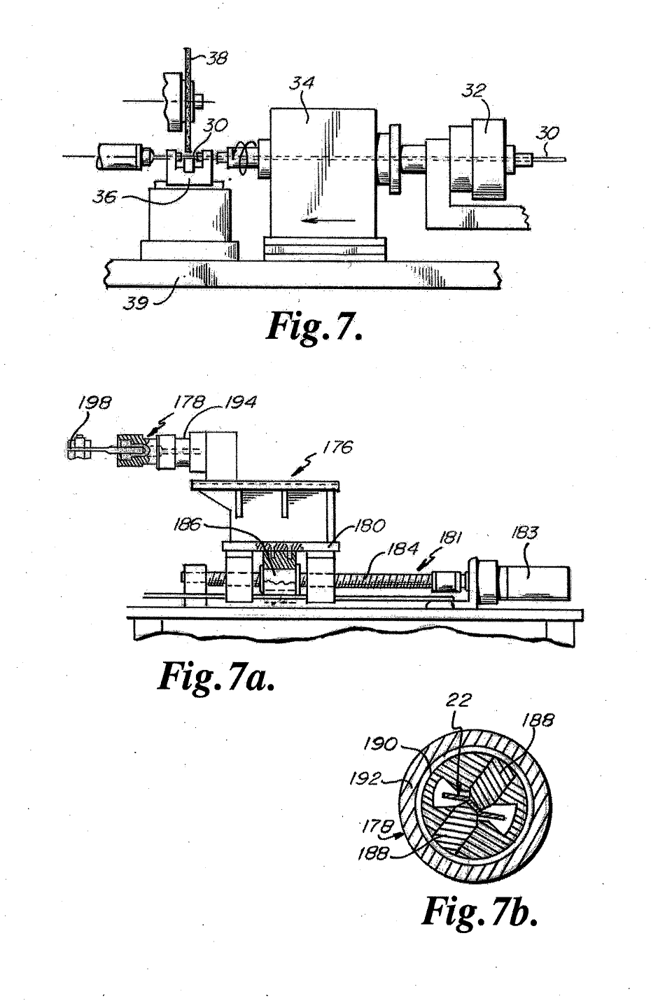

The present manufacturing method includes using blanks 30 that are of the same diameter or circumferential span, thus generating instruments 12, all having shanks 16 having the same diameter or circumferential span, or using blanks 30 that are of different diameters or circumferential spans, making instruments 12, all having shanks having different diameters or circumferential spans. The process is schematically shown in FIG. 6. and includes:

providing a blank 30 having a circumferential span that is substantially smaller than the circumferential span of the finished working portion 22 of the finished instrument 12 in process 1;

forming a pilot portion 10 near the end of the instrument close to the working portion 22 by shaping or removal of material in process 2; and

positioning at least a portion of said blank 30 adjacent a die having walls defining at least partially the shape and circumferential span of a working portion 22 of a dental instrument 12 and compressing said portion of said blank 30 against said walls of said die with a force sufficient to deform said portion of said blank 30 adjacent the die into a shape reflecting said walls of said die to form a working portion 22 in process 3.

The pilot portion 10 may be formed by a number of methods, including grinding, or any other similar process, such as polishing. Details of an exemplary method may be found in U.S. Pat. Nos. 5,464,362, and 5,816,807, the contents of which are incorporated herein by reference. These patents disclose the manufacture of dental drills by removing or grinding material from the working portion 22. In the present invention, any grinding, if performed, may be used for forming the pilot portion 10.

The process may further include a treatment process for treating at least a portion of the instrument 12 including at least a portion of the shank 16, the working portion 22, the pilot portion 10 or combinations thereof. The treatment process may be carried out after the instrument 12 is formed or prior to the grinding or compression process also, as shown in dotted line in FIG. 6. The treatment process may also be repeated.

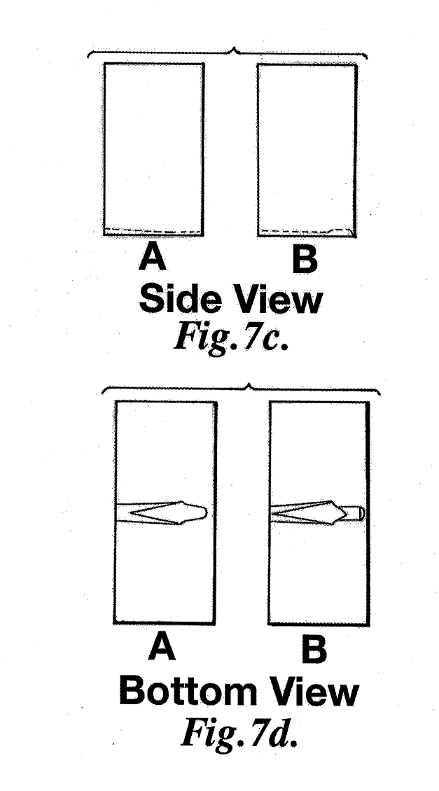

In one embodiment, the processes may be performed in any other order, including a reverse order. These processes may be carried out using an apparatus as exemplified in FIG. 7, described below.

FIG. 6a is a side view of the compression process of the present invention as exemplified in FIG. 6. The blank 30 moves into the location where the two parts of a die or mold M is located. The two parts closes, and in the process, compresses a portion of the blank 30 towards the proximal portion with a force F that is sufficient to deform the blank into the shape of the walls of the die M. The blank 30 may be cut to length, as illustrated, or inserted between two pieces of the mold as it unrolls from a spool, is placed between the two pieces of the mold. Compression force is applied as illustrated and deformation on the wire blank forces it into the shape of the finished piece. The process may require one or more “hits” from one or more directions to achieve the desired result.

FIG. 6b shows a top view of the compression process of the present invention as exemplified in FIG. 6.

FIG. 7 schematically illustrates a portion of an exemplary machining apparatus for practicing a part of the method of the present invention. The grinding process itself may be any known process, such as that described in U.S. Pat. No. 5,464,362, as noted above, the content of which is incorporated herein by reference.

An instrument 12 may be made from a blank 30 having a circumferential span, for example, a diameter that is the same as the diameter of the shank 16. In accordance with an illustrated embodiment of the present invention, the blank 30 may be supplied from a continuous spool, as noted above, and may be positioned to extend through an axial feed block 32 and an indexing block 34 as shown in FIG. 7. A holding fixture 36 is positioned to support the forward end of the blank 30 adjacent the periphery of a rotating grinding wheel 38.

In the embodiment as shown in FIG. 7, the blocks 32, 34 may be advanced so that the blank 30 may move axially past the rotating grinding wheel 36 at a speed of, for example, between about 3 to 8 inches per minute (75 mm to about 200 mm), and more for example, of not more than about 5 inches (125 mm) per minute, if a blank of nickel-titanium is used. In other embodiments, higher rotation rates may be used. Concurrently with this axial movement, the indexing block 34 may be stationary or it may have a slight translational movement, for forming a short rounded pilot portion 10, such as shown in FIG. 2. In FIGS. 2 and 2a, when the pilot portion 10 is a short portion extending from the end 24 of the working portion 22, the end of the pilot portion is ground to have either a rounded end, as shown in FIG. 2b, or substantially rounded end, as shown in FIG. 2c.

The blank 30 may move past the wheel once or more than once for forming the pilot portion 10, and thus the blank 30 may be positioned with respect to the wheel 38 such that the full depth of any cut is removed in a single pass or multiple passes, respectively.

The grinding wheel 38 may be rotated at a relatively slow surface speed of, for example, not more than about 3000 feet per minute, and more for example, not more than about 2200 feet per minute. Further, the wheel 38 may be composed of a relatively fine grit, which is greater than, for example, about 200 grits, and more for example, about 220 grits. The wheel having the above grit sizes may be fabricated from silicon carbide. In other embodiments, diamond particles may also be used as the grinding surfaces.

The grinding wheel may also be rotated at higher surface speeds. At the higher speeds, more than one pass may be employed.

In some embodiments, instead of a grinding wheel, a polishing station may be present, to polish the end of blank 30 for forming a smooth end of a pilot portion 10.

After or before forming the pilot portion 10, the blank 30 may be advanced to the compression station at point B, having a pair of die, 188, as shown in FIG. 7b, for forming the working portion 22. As mentioned above, the walls of the die may be configured to any form or shape for generating various shapes of the working portion 22.

The compression process may be carried out by an apparatus similar to that used for making a drill, but capable of handling a smaller instrument. An exemplary instrument 12 is shown in FIG. 7a, some of the details may be found in U.S. Pat. No. 6,290,439, the content of which is incorporated herein by reference.

As noted above, compressing may include coining, stamping, cold pressing, molding or casting. While coining, stamping, cold pressing may be operated at ambient temperature or higher, molding or casting may be performed at elevated temperatures. The compressing process may include any or a combination of the above.

As shown in FIG. 7a, a size stamp station 176 is shown to include a size stamp clamp 178. The arrow 41 represents the direction of advance. The stamp clamp 178 also includes a size stamp die assembly including an alignment fixture 190, such as a spider, and a plurality of size stamp dies 188 which are held within the alignment fixture, a cross-sectional view is shown in FIG. 7b. The size stamp clamp 178 may also include a closure 192, which may be adapted to receive the size stamp die assembly. The size stamp station 176 may also include devices, for example, a hydraulic cylinder assembly 194 which operates under control of a controller for urging the closure over the size stamp die assembly such that the size stamp dies 188 are closed about the leading end of the continuous blank material 30. In another embodiment, the blank may also be in discrete lengths.

FIG. 7a shows an exemplary apparatus for performing this compression process is set up separate from the machine for handling the blank 30 and forming the pilot portion 10. In another embodiment, the compression apparatus may be incorporated into the blank handling and grinding apparatus shown in FIG. 7.

The size stamp dies 188 as shown in FIG. 7b may have a shape which matches the shape of the part to be held by the size stamp clamp 178, for example, the shape of the working portion 22 of an endodontic instrument 12 of the present invention.

In one embodiment, when a continuous blank stock 30 is used, the blank 30 may be held by the size stamp clamp 178 while the controller (not specifically shown here) may advance the saw 198 toward the continuous blank 30 so as to cut at a location proximate the forward end of the instrument 12, i.e., at a location proximate the pilot portion 10, thereby separating the leading part from the remainder of the continuous blank 30. The cutting station (not shown), may also include a proximity sensor, operably connected to the controller, for detecting the advancement of the saw 198 to a predetermined position. Thereafter, the controller may retract the saw 198 to its initial position. In other embodiments, blanks 30 having a discrete length may be used.

Once the continuous blank stock 30 has been cut and the controller has retracted the saw 198, the controller may also move the saw station in a downstream direction until the saw is aligned with the rearmost or proximal portion 16a of the shank 16 of the instrument 12. The saw may then rotatably advance once again to cut through the continuous blank stock 30 at a location proximate the proximal end 16b of the shank 16.

After the blank 30 has been cut to the desired size, the size stamp station 176, again under control of the controller mentioned above moves the size stamp platform 180 in a downstream direction as indicated by arrow 41. In one embodiment, the size stamp station platform 180 may be moved in a downstream longitudinal direction by a linear distance which exceeds the longitudinal growth of the continuous blank stock 30 in the downstream longitudinal direction during one sequence of forming operations. For example, the size stamp station may be moved in a downstream longitudinal direction by the expected amount of longitudinal growth of the continuous blank stock 30 in the downstream direction plus a predetermined additional amount, such as 0.100 inch.

Accordingly, additional portions of the continuous blank stock 30 may now be forged without contacting the discrete part held by the size stamp clamp 178. Thus, the forming method and apparatus of the present invention may continue to process the discrete part held by the size stamp clamp while forming additional portions of the continuous stock material at the same time.

Once the size stamp station 176 has completed stamping or compression operations, the size stamp station 176 can eject the stamped part which may be directed by, for example, a chute, a conveyor or the like, into a bin. In one aspect, the size stamp station may include a kicker rod which may be spring extended so as to eject the stamped part once the size stamp dies 188 have been opened.

The compressing process has been described as a stamping process, but it may also include swaging, coining, hot or cold forming, forging, pressing, molding, casting or otherwise subjected to mechanical compression to “flare” the portion of the blank 30 adjacent the die such that it is flattened in one embodiment to have a circumferential span that is greater than the unflattened or round portion of the blank 30 and having a thickness that is smaller than the unflattened shank portion 16, as shown in FIG. 2. In one embodiment, the edges of the flattened portion may be polished, machined, sheared or further formed into sharp cutting edges. FIGS. 7c and 7d show the side and top views respectfully of two pairs of molds M used for compressing the blank 30, as described in the illustrated process in FIGS. 6, 6a and 6b. As noted above, the blank 30 may be of any cross sectional shape and have a parallel or tapered shape before forming.

The blank 30, which may be cut to length, as illustrated, or inserted between two pieces of the mold as unrolled from a spool, as discussed above, may be placed between the two pieces of the mold.

In another embodiment, as noted above, the compression may generate a working portion 22 having at least one projection including the forward and trailing portions that are typically at an oblique angle to the longitudinal axis. In another aspect, one or more of these projections may be straight, radiating outward about the working portion 22 in one plane, as shown in FIG. 2a.

In another embodiment, each projecting section 18 may not be straight, but may twist about the longitudinal axis of the shank portion 16 not more than 359 degrees, as shown in FIG. 3.

In yet another embodiment, the projections 18 may be straight or twisted, provided that they do not intersect each other, as shown in FIG. 3a.

The severed blank/instrument 12 may then be further treated, as is also discussed above. The treatment may be performed on the entire instrument 12 or at select portions and may include coating, sandblasting, anodizing, ion implantation, electro-polishing, etching, or combinations thereof, as disclosed above. Any or combinations of these treatments may serve to modify the surface properties of the instruments 12, as disclosed above. Other treatments, including cryogenic treatment, heat setting or combinations thereof, may serve to improve the bulk properties, for example, the strength of the metal, polymer or alloy, by, for example, modifying the molecular structure of the base material. These may also be used in combination with the surface treatments mentioned above, either before or after any of the other treatments, provided that one type of treatment does not adversely change or affect the desirable effects imparted by another type of treatment, as noted. In general, the properties least likely to be affected by other treatment methods are performed first.

The treatments including coating, sandblasting, anodizing, ion implantation, electro-polishing, etching or combinations thereof, may be performed to modify the surfaces of at least a portion of the working portion 22, and/or the shank 16, and/or the pilot portion 10, as noted above. The treatment may also act to remove any burrs that may form during the process.

In addition, these surface treatments may also remove any oxidized layers, for example, oxide layer that may be present on the surface of the blank that is generated during the manufacturing process of the blank 30. The oxidized layer may be regenerated even after the treatment, but not to the same extent as the untreated surfaces. The removal of the oxidized layer may also improve the cutting efficiency of the working portion 22.

A suitable cryogenic treatment is described in U.S. Pat. No. 6,314,743, the content of which is incorporated herein by reference. An exemplary treatment may involve a cryogenic cycle having a cool down phase from an initial start time, during which the blank 30 may be cooled down in a dry cryogenic environment to about −300° F., over a span of between about six (6) and eight (8) hours, followed by a cryogenic hold phase during which the blank 30 may be held at about −300° F. over between about twenty-four (24) and thirty-six (36) hours, followed by a cryogenic ramp up phase during which the blanks are ramped up to about −100° F. over between about six (6) and eight (8) hours. Then a first tempering cycle having a ramp up phase may be performed, during which stage the blank is ramped up in a dry tempering environment to about 350° F. over about one-half (½) hour, followed by a hold phase during which the blank 30 may be held at about 350° F. over about two (2) hours, followed by a ramp down phase to below about 120° F., but not generally all the way to the ambient temperature, over between about two (2) and three-and-half (3½) hours. A second tempering cycle may follow which may have a time-temperature profile fairly comparable to the first tempering cycle. In some methods, a third tempering cycle may be performed.

The cryogenic ramp down phase may be arranged to have a varying rate of descent. For example, the descent may be steeper initially from ambient to about −100° and then more gradual thereafter for temperatures below −100° F. to about the cryogenic hold temperature of about −300° F. The temperature descent from the start time at ambient temperature to the about −100° F. level may be achieved over about the first one (1) hour after the start time, while the temperature descent from below about −100° F. to about −300° F. may be achieved over between about five (5) and seven (7) hours.

The cryogenic ramp up phase may also have a varying rate of ascent, for example, that may correspond to an exponential decay of the cryogenic hold temperature from the about −300° F. to about −100° F. over between the about six (6) and eight (8) hours. The exponential decay of the cryogenic hold temperature from the about −300° F. to about −100° F. may also include a stage when a temperature of about −200° F. is not reached from the base hold temperature of −300° F. until six (6) hours into the cryogenic ramp up phase, while the remaining decay up to −100° F. occurs over a next two (2) hours. In other embodiments, the exponential decay of the cryogenic hold temperature from the about −300° F. to about −100° F. may be arranged to transpire such that a temperature of about −200° F. is not reached from the base hold temperature of −300° F. until five-and-half (5½) hours into the cryogenic ramp up phase, the remaining decay up to −100° F. occurring over a half (½) hour period.

In an exemplary embodiment, the cryogenic environment may be provided by a Dewar chamber and the tempering environment may be provided by a convection oven. Accordingly, the transition between the cryogenic cycle and the first tempering cycle would entail physical transfer of the blank from Dewar chamber to the convection oven.

Typically, a hold down phase at about −300° F. may extend between about twenty-four (24) and thirty-six (36) hours. During this “hold phase” the blank 30 may thermally contract. If the blank 30 is made of metal or a metallic alloy, it is surmised that the microstructure re-organizes itself to become more spatially uniform. This uniformity may provide stronger blanks for making the instruments 12 by decreasing the packing density defects.

Another cryogenic process is disclosed in U.S. Pat. No. 6,332,325, incorporated herein by reference. The process subjects an article of manufacture to extreme negative temperatures and cycling the article between a set of negative temperatures for a number of cycles. The process is completed by heating the article to an extreme positive temperature and then allowed to cool to ambient room temperature. It is shown that this cryogenic thermal cycling process strengthens the article by realigning its molecular structure to eliminate micro-cracking and other manufacturing deforming characteristics.

Other cryogenic treatment methods may be found, for example, U.S. Pat. No. 4,482,005 (Voorhees), or U.S. Pat. No. 5,259,200 (Nu-Bit, Inc.), the content of which is incorporated herein by reference. The Voorhees patent discloses a cryogenic cycle having ramp down and ramp up phases flanking a wet or immersion “soaking” phase. The Voorhees discloses that for “tool steel”, the wet process produces an instrument 12 with longer lasting sharpness. The Nu-Bit patent discloses a quenching process by essentially dropping a target into a liquid nitrogen bath, and let set there for the ten (10) minutes or soon, sufficient time for the liquid nitrogen to boil away. After the bath, the instrument 12 is brought back to room temperature by a jet stream of room-temperature air, making the entire process a forty minute start to finish (including the 10 minute bath) process. This quick dip method reports a gain of up to a fifty fold (50×) improvement in drill bits. Both of these methods may have to be modified to be practiced for blanks 30 used to make fine instruments like endodontic files.

The cryogenic treatment may be amenable to blanks 30 after they have been manufactured, for example, after they have been drawn into the form of blanks 30, other treatment process may also be amenable to be performed during, for example, the extrusion or drawing process. For example, heat treatments or varying drawing speeds may be used to modify the properties of the blanks 30, for example, to strengthen the blanks 30, during their manufacturing process. For heat setting treatments, a cycling between hot and cold may be employed. The rate of the heating and cooling cycles may also be varied. Other thermal treatments may include localized laser treatment. By varying the aging temperature, the drawing or extrusion rates, the rate of heating and cooling cycles, any irregularities in the molecular structure or molecular packing may be modified. Multiple incremental drawing or deformation may also result in better uniformity and better properties than single drawing process.

Some examples of these processes may be found in U.S. Pat. Nos. 4,704,329, and 6,332,325, the contents of which are incorporated herein by reference.

While some of these treatment methods may be more amenable to blanks 30 than instruments 12, they may be used for instruments 12 also, with some modifications. For example, the method discussed in U.S. Pat. No. 6,332,325 may be used to strengthen the blank 30 by realigning its molecular structure to eliminate micro-cracking and other manufacturing deforming characteristics, as noted above. Therefore, though some of these processes have been described with respect to the blank 30, the instruments 12 may be described in similar manners.

Coating, sandblasting, etching, anodizing, ion implantation or electro-polishing, as noted above, may be used to modify the surface 30. For example, a micro-abrasive sandblasting device disclosed in U.S. Pat. No. 6,347,984 may be a suitable device for treating endodontic instruments 12 of the present invention, the content of which is incorporated herein by reference. Another suitable device may be one disclosed in U.S. Pat. No. 5,941,702, the content of which is also incorporated herein by reference. This exemplary device disclosed is a dental air-abrading tool typically used for etching hard surfaces to enhance bond strength of adhesives, which includes a solid body having internally reamed passageways through which a gaseous fluid and an abrasive material are carried. A connector is mounted on one end of the body for connecting one of the body's internal passageways to a supply of gaseous fluid and a nozzle is mounted on the other end of the body for directing the gaseous fluid to a surface. A supply of an abrasive material is coupled to another internal passageway of the body. The nozzle includes an internal mixing chamber for mixing the gaseous fluid and abrasive material entering therein from the body's internal passageways. Some slight modifications may be made to adapt it for use in the present invention

Other physical alterations of the surface such as burnishing, may also result in a surface layer with reduced excess oxides.

Other exemplary treatment methods may be found in U.S. Pat. Nos. 6,605,539, 6,314,743, 5,775,910, and 5,393,362, the contents of all of which are hereby incorporated by reference.

Chemical etching may also be used and may be carried out in any known process, including nitric acid passivation.

Ion implantation is another method that may be used, to impart changes to either small or large regions of the surface of the blank 30, for example, to generate an amorphous surface, which may lead to increased surface hardness, reduced surface friction coefficient, increased wear resistance, reduced surface wetting behavior, and even an enhancement in passivation, if desired. Ions useful for implantation may include oxygen, nitrogen, carbon, boron, cobalt. Process conditions during ion implantation may also be controlled to minimize hydrogen embrittlement.

When the modification is performed on the instrument 12 after the instrument has been formed, the coating, sandblasting, anodizing, ion implantation, etching or electro-polishing process may be performed on the entire instrument 12 or on selected portions of the instruments 12, to modify the entire instrument 12 or only the desired portion or portions. The process may also remove any burrs or irregularities generated during the manufacturing process while creating a modified surface structure at the same time.

In addition, the surface treatments may also remove any oxidized material, for example, an oxide layer that may be present on the surface of the blank 30 that is generated during the manufacturing process of the blank 30. The oxidized layer may be regenerated even after the treatment, but not to the same extent as the untreated surfaces. The removal of the oxidized layer may also improve the cutting efficiency of the working portion 22.

In another embodiment, after the treatment, or as the treatment process, a coating may be formed on the surface. This coating may, on the one hand, minimize the re-forming of the oxidized layer, while at the same time provide friction reduction and/or durability enhancement, as discussed further below.

In a further embodiment, the existence of the oxide layer may be advantageous in improving corrosion resistance, durability and/or finishing of the surface. An oxide layer of titanium may, for example, impart coloring to the surface based on the thickness of the layer and may be utilized as a wear or depth indicator. Oxide layers thicker than an untreated passivation layer may also impart increased corrosion resistance and durability as many metal oxides are extremely hard and thicker layers may be less prone to wearing that may expose the metal surface and lead to corrosion. Increasing the thickness of the oxide layer may also be useful in preserving the layer when exposed to environments where oxygen is not available to regenerate the layer.

Coating, sandblasting, anodizing, ion implantation, etching or electro-polishing may also modify the working surfaces 18, whether performed on the blank 30 or the instrument 12. When performed on the blank 30, the treated areas remain after the instrument 12 is formed as there is no grinding or removal of material from the blank involved in a typical process of the present invention. Additional treatment may be performed on portions of the instrument 12 after compression and/or grinding, if desired. In other words, the treatment processes may be repeated.

In addition, other chemical surface treatments for the blank 30 may be employed including coatings for friction reduction and/or durability. Some of these coating may include titanium nitride coating, tungsten carbide coatings, diamond-like carbon coatings, chromium coating, calcium immersion, and others for maintaining and improving the sharpness of the working surfaces 18 and to minimize the built up of oxide layers, as noted above. The formation of titanium nitride on a passivated surface was reported to enhance the barrier to further Ni2+ ion migration, as noted in an article by L. Tan, W. C. Crone/Acta Materialia 50 (2002) 4449-4460, the content of which is hereby incorporated by reference.

Some coatings for example, DLC or titanium nitride, may have different colors from the blanks 30. Any change in the color of the coating on the working portion may then act as a wear indicator.

Other treatments may also impart a different color to the treated portions. Any change in color on the working portion may also act as a wear indicator.

Further, a treatment process having a sequence of first reducing the oxide layer prior to drawing, then add treatments such as electro-polishing, anodizing, coatings including various coatings mentioned before, and drawing again, may be used.

In one embodiment, the instrument 12 of the present invention may have a handle 25 at the proximal end 16a of the shank 16 for manual manipulation, as exemplified in FIG. 5. In another embodiment, the instrument 12 may have a handle 25 that is adapted for attachment to a mechanical handpiece, for example, a rotary or vibratory handpiece, as exemplified in FIGS. 5a and 5b. The handle 25 may be attached by crimping, by an adhesive, or combinations thereof.

When adapted for rotation by means of a mechanical handpiece, the speed of rotation may be at any conventional level up to a level of about 2000 to about 3,000 rpm. This is possible because of the short working portion 22 and smaller areas of contact between the working surfaces 18 and the canal walls. This is an improvement over the traditional instruments having a working portion along almost the entire length of the instrument.

The handle 25 may be attached by crimping, by an adhesive, or combinations thereof. Surface modification such as roughening, made by coating, sandblasting, or chemical modification made by chemical etching, anodizing or ion implantation on or coating of the proximal end of the non-working shank either macroscopically or microscopically, depending on the treatment, may aid in the attachment of the shank to a handle 25, as shown in FIGS. 5, 5a and 5b, result in the increase of the attachment strength of the shank 16 to the handle 25, and decreasing the chances of separation between the handle 25 and the instrument 12 during operation, as discussed further.

This improvement in attachment also enables the instrument 12 to be rotated at the higher speeds with lower incidences of detachment between the instrument 12 and the handle 25.

When the attachment strength between the handle 25 and the instrument 12 is increased, any breakage, if it happens, may be more likely to occur at any weak points generated during the manufacturing process, rather than the separation between the handle 25 and the proximal end 16a of the instrument 12.

In one embodiment, to increase the likelihood that such breakage may occur along the shank portion 16 rather than at the transition between the working surface 22 and the pilot portion 10, or the working portion 22 and the distal end of the shank 16b, the shank 16 may be tapered, such as exemplified in FIG. 3d, so that any weak point may more likely to be towards the proximal end 16a of the shank 16, and any broken parts if lodged in the canal, may be more easily removed.

In FIG. 3d, the proximal end 16a of the shank 16 has a smaller diameter than the distal end 16b and the transition between the distal end 16b of the shank 16 and that distal end 24 of the working portion 22 is gradual and smooth, reducing or minimizing any stress that may be created by the stamping process.

In another embodiment, if desired, the shank 16 may also be ground to have a portion 16c having a reduced circumferential span or diameter, as shown in FIG. 3c. This reduced diameter portion 16c may take the shape of a groove (U-shaped) or a notch (V-shaped). In one aspect, this reduced diameter portion 16c provides a predictable break point, in case the instrument 12 encounters some blockage in the canal that impedes its cutting action such that the instrument 12 does not break in the tooth, but at the reduced diameter portion 16c for easier retrieval from the tooth. In one aspect, this reduces the chance of having a broken piece that may be lodged deep within the canal of the tooth. In another aspect, in addition to serving as a predetermined weakness point, the reduced diameter portion 16c may also be adjusted to serve as a depth of cut indicator.

Any surface treatments on the working portion may also lead to better cutting efficiency. This may also lower the degree of discomfort for the patient.

A similar process and apparatus as exemplified above may be used for the manufacturing of a group of a set of instruments 12. In one embodiment, each blank 30 in the group has a different circumferential span or diameter may be used to make one instrument 12 having a working portion 22 having one circumferential span that is different from all other instruments 12 in the group and set. The thickness of the working portion 22 may be substantially the same as that of other instruments 12 in the group, such as exemplified in FIG. 4, discussed above.

In another embodiment, each blank in the group having an identical circumferential span may be used to make one instrument 12 having a working portion 22 that is different from all other instruments 12 in the group, such as exemplified in FIG. 4a, also discussed above. This process has the advantage of stocking only one size of starting blanks 30 for making each instrument 12 in the set having a different maximum circumferential span, saving material and process cost.

In prior art, endodontic instruments 12 were ground into the desired shape. This grinding process is time consuming, requires many procedural steps and requires the use of very specialized, expensive machinery. This grinding process also generates imperfections and flaws on the surface of the finished working portion. These imperfections and flaws may lead to premature failure, increasing the risk to the patient, reducing the instrument's useful life and causing it to be more expensive for the dentist and the patient.

The present method substantially eliminates the grinding process except for the pilot portion 10, if grinding is the chosen process. The shank 16 may be made without any grinding process and is therefore not marred through the manufacturing process. The instrument's fatigue life may be extended because the surface of the shank 16 substantially kept in its original state as that of the blank 30. Finally, this simplified forming process allows for less complex, less specialized equipment and less expensive equipment to be used for manufacturing, such as equipment useful for making drill bits, as exemplified above. The time to manufacture any instrument is reduced.

The working portion 22 of the instrument 12 of the present invention may typically be very narrow and sharp for increasing the cutting efficiency. For example, a flattened working portion 22 may typically be made very thin, thus reducing the surface area contact of the blade with the root canal walls, as noted before. These thin blades, for example, typically from 0.01 mm to 1.00 mm thick, more for example, from 0.05 mm to 0.25 mm thick, also allows for more space for the previously cut material to reside before being irrigated and suctioned from the canal. When compared to prior art, this extra space may also help to reduce the loss of cutting efficiency that the cut material often causes by interfering with the cutting action of the blades. Thus, thin blades not only increase cutting efficiency, but also reduce torsional stress on the shank 16, which stress twisting along the longitudinal axis of the shank 16 may be a primary cause of premature instrument breakage.

While particular embodiments of the present invention have been shown and described, it will be obvious to those skilled in the art that changes and modifications may be made without departing from the invention in its broader aspects. Therefore, the aim in the appended claims is to cover all such changes and modifications as fall within the true spirit and scope of the inventions. The matter set forth in the foregoing description and accompanying drawings is offered by way of illustration only and not as a limitation. The actual scope of the invention is intended to be defined in the following claims when viewed in their proper perspective based on the prior art.

1-29. (canceled)

30. A set of groups of endodontic instruments, each instrument comprising:
a relatively short working portion having a proximal end and a distal end;
a pilot portion adjacent the proximal end of the working portion; and
a shank portion adjacent the distal end of the working portion, said shank portion having a longitudinal axis, at least a portion of the shank portion has a substantially smaller average circumferential span than the working portion, and has a different circumferential span from that of instruments in other groups;
wherein the thickness and circumferential span of one of the working portions in one group is different from those of others in the group.

31. The instrument of claim 30 wherein said at least a portion of each of the instruments including the shank, the working portion, the pilot portion or combinations thereof has been treated.

32. The instrument of claim 30 wherein said working portion comprises projecting sections extending outwardly from the shank portion; projecting sections in one plane; projecting sections twisting not more than 359° about the longitudinal axis of the shank; projecting sections that are non-intersecting; or combinations thereof.

33. The instrument of claim 32 wherein said working portion comprises at least two projection sections.

34. The instrument of claim 30 wherein the thickness of the working portion of an instrument in one group is the same as an instrument in another group.

35. The instrument of claim 30 wherein the thickness of the working portion of an instrument in one group is the same as an instrument in every other group.

36. The instrument of claim 30 wherein the thickness of the working portion all instruments in the set is different.

37. The instrument of claim 31 further comprises a handle attached to the treated portion of the shank portion.
